(19) United States
(12) Patent Application Publication
(10) Pub. No.: US 2025/0214902 A1
(43) Pub. Date: Jul. 3, 2025

(54) METHOD FOR PRODUCING SILICON CARBIDE COATED REFRACTORY GRAINS AND SILICON CARBIDE COATED REFRACTORY GRAINS

(71) Applicant: Refractory Intellectual Property GmbH & Co. KG, Wien (AT)

(72) Inventors: Danting ZHAO, Dalian, Liaoning (CN); Hilmar SCHULZE-BERGKAMEN, Witten (DE)

(21) Appl. No.: 18/880,503

(22) PCT Filed: Aug. 16, 2023
(86) PCT No.: PCT/EP2023/072508

§ 371 Date: Dec. 31, 2024

(30) Foreign Application Priority Data
Aug. 24, 2022 (EP) EP22191951

(51) Int. Cl. C04B 35/628; C04B 35/101

(52) U.S. Cl. CPC C04B 35/62834; C04B 35/101; C04B 35/62807; C04B 35/62886; C04B 35/62894; C04B 2235/3217; C04B 2235/3418; C04B 2235/3826; C04B 2235/5472

(57) ABSTRACT

The present invention provides a method for producing silicon carbide coated refractory grains comprising the following steps: a. Providing core refractory grains; b. Spraying an oxide sol onto said core refractory grains; c. Optionally mixing said core refractory grains with said oxide sol in a mixing device; d. Adding silicon carbide grains to said core refractory grains; and e. Mixing the mixture obtained in step d to obtain coated refractory grains having a core and a first silicon carbide coating layer.

The present disclosure relates to a method for producing refractory grains coated with silicon carbide (SiC) and to refractory grains coated with silicon carbide, as well as to a batch for producing a shaped refractory product and to a method for producing a shaped refractory product and to a shaped refractory product comprising refractory grains coated with silicon carbide.

### BACKGROUND OF THE INVENTION

In the sense of the present invention, the term “refractory product” refers to a product produced from inorganic refractory raw materials and having a service temperature above 600° C., and preferably having a pyrometric cone temperature equivalent (“Kegelfallpunkt”) above 1500° C. according to ISO 836 and DIN 51060. The pyrometric cone temperature equivalent (“Kegelfallpunkt”) can be determined according to ISO 528 and DIN EN 993-12.

Raw materials for producing a refractory product are commonly based on metal oxides such as, e.g., aluminium oxide (“alumina”, Al₂O₃), magnesium oxide (“magnesia”, MgO), silicon dioxide (“silica” SiO₂), calcium oxide (“calcia”, CaO), zirconium oxide (“zirconia”, ZrO₂) or chromium oxide (“chromia”, Cr₂O₃). Further common raw materials are based on mixed compounds such as aluminium silicate (also referred to as “aluminosilicate”), magnesium aluminate (i.e., spinel, preferably stoichiometric spinel having a chemical formula of MgAl₂O₄) or calcium magnesium oxide (“doloma”, CaO·MgO). In the present disclosure, “aluminium silicate” refers to compounds based on Al₂O₃ and SiO₂, having a chemical formula of xAl₂O₃·ySiO₂·zH₂O, wherein x and y are natural numbers equal or greater than 1 and z is 0 or a natural number equal or greater than 1.

The above mentioned refractory raw materials are commonly derived from natural sources, such as naturally occurring minerals, which may be chemically and/or physically treated to obtain refractory raw materials.

For example, major sources for magnesium oxide (“magnesia”) are the minerals magnesite (composed of MgCO₃) and periclase (composed of MgO). Magnesite is transformed to MgO by temperature treatment, e.g., calcination or burning. Similarly, the main source for calcium magnesium oxide is the mineral dolomite, which can be transformed to the oxide by temperature treatment, e.g., calcination or burning. Calcium magnesium oxide is herein also referred to as “doloma”.

Major sources for aluminium silicates are the minerals mullite, andalusite, kyanite, sillimanite and kaolinite, as well as fireclay.

Major sources for aluminium oxide are the natural ore bauxite and the mineral corundum. Bauxite is an aluminium ore which comprises various aluminium hydroxide minerals, in particular gibbsite (γ-Al(OH)₃), boehmite (γ-AlO(OH)) and diaspore (α-AlO(OH)), as well as iron compounds such as haematite (Fe₂O₃) and goethite (FeO(OH)). Bauxite may also contain some amounts of kaolinite (Al₂Si₂O₅(OH)₄), anatase (TiO₂), ilmenite (FeTiO₃ or FeO·TiO₂) and other minerals such as periclase (MgO). Bauxite is typically calcined to transform the aluminium hydroxides into aluminium oxides to obtain a refractory raw material. As used herein, the term “bauxite” refers to calcined bauxite. Typically, bauxite has an alumina content of ca. 75 to 88 wt. % after calcination.

From bauxite, also refractory raw materials containing a higher content of alumina can be produced by several treatment steps, in particular by sintering and/or fusion steps as well as purification steps. Thereby, brown fused alumina, white fused alumina, calcined alumina or tabular alumina can be obtained. It is known that refractory products produced from those higher purity alumina raw materials may have superior chemical and physical properties over products produced from bauxite, e.g., leading to an improved wear resistance under operating conditions. However, due to high costs and time efforts for purifying and treating natural minerals, it is desired to perform as few treatment steps as possible to obtain a suitable refractory raw material.

It is further desired to produce high-quality refractory products, i.e., refractory products with excellent chemical and physical properties, from such refractory raw materials. In terms of chemical properties, it is especially desired to achieve a high corrosion resistance, since refractory products are often exposed to corrosive chemical compounds, e.g., chemical compounds present in the slag in steel production. In terms of physical properties, it is especially desired to achieve a high cold crushing strength (CCS) since a CCS is characteristic for products with high stability against mechanical wear.

To improve the chemical and physical properties of the final refractory product, it is possible to mix high-quality raw materials, which are known to result in the desired properties, into the batch for producing the product.

In the present disclosure, a “batch” is to be understood as a composition of one or more components or raw materials, including additives such as binders, by which a refractory product can be produced by means of a temperature treatment, preferably by tempering and/or sintering.

It is further known that the chemical and physical properties of refractory raw materials can be adjusted by adding a coating on the raw material grains. For example, in WO 2021/165300 A1, a zirconia coating is attached to core grains made of magnesia, magnesite, doloma or dolomite, to improve the elasticity behavior of the final product. In EP 3868731 A1, a chromia coating is attached to core grains made of magnesia-chromite and in EP 3613716 A1 a coating of alumina is attached to core grains of magnesia. In these prior art documents, the coating is attached to the core grains using an organic liquid, in particular polyvinyl alcohol.

Ren Bo et al. (Ceramics International, vol 43, no. 14, 22 May 2017, pp. 11048-11057) describe bauxite-SiC refractories produced from raw materials comprising silica sol-coated lightweight mullite aggregates and SiC aggregates (section 2.1 and 2.2). The silica sol-coated lightweight mullite aggregates were used to decrease the thermal conductivity of the products. No further coated refractory grains are described.

Sternitzke M. et al. (Journal of the American Ceramic Society, vol. 81, no. 1. January 1998, pp. 41-48) describe alumina/SiC nanocomposites produced by treating alumina powder with polycarbosilane (PCS) using a titanate coupling agent, followed by pyrolysis to form silicon carbide from PCS.

### SUMMARY OF THE INVENTION

It is an object of the present invention to provide refractory products with excellent chemical and physical properties made from easily available and cheap raw materials.

In particular, it is an object of the present invention to provide a refractory raw material which allows for the production of a refractory product having excellent chemical and physical properties, especially in terms of corrosion resistance and parameters such as the cold crushing strength, and to provide a method for obtaining such a raw material.

This object is solved by a method for producing silicon carbide (SiC) coated refractory grains comprising the following steps:
a. Providing core refractory grains;
b. Spraying an oxide sol onto said core refractory grains;
c. Optionally mixing said core refractory grains with said oxide sol in a mixing device;
d. Adding silicon carbide grains to said core refractory grains; and
e. Mixing the mixture obtained in step d to obtain coated refractory grains having a core and a first silicon carbide coating layer.

The object is further solved by a silicon carbide coated refractory grain comprising the following components:
a. A core refractory grain, and
b. at least one coating layer, wherein said at least one coating layer comprises the following components:
   i. agglomerates of oxide particles; and
   ii. silicon carbide grains.

The term “core refractory grain” herein refers to a grain of refractory raw material which is to be coated with silicon carbide.

The term “sol” is to be understood as a stable mixture of solid colloidal particles in a liquid. An “oxide sol” is to be understood as a sol in which the solid colloidal particles are composed of an inorganic oxide compound. The term “colloidal” in this context means that the oxide particles are nanometer-sized, thus having a size in the range of one nanometer to several hundreds of nanometers.

It is to be understood that the oxide particles of the oxide sol are smaller than the “grains” described herein, i.e., the core refractory grains and the silicon carbide grains.

The core idea of the present invention is based on the finding that an oxide sol can be used to attach silicon carbide grains on core refractory grains to obtain a silicon carbide coating on the core refractory grains. It has surprisingly been shown that an excellent adherence of the silicon carbide grains to the surface of the core grains can be achieved by using an oxide sol to attach, i.e., to bind, the silicon carbide grains to the core refractory grains. This allows to obtain coated grains having surprisingly thick and uniform silicon carbide coatings, which coated grains can be used to produce a high-quality refractory product with excellent chemical and physical properties, especially in terms of its corrosion resistance and parameters such as the cold crushing strength.

With the present invention, coated grains having similar properties as grains made of bulk silicon carbide can be obtained in terms of their chemical and physical properties. Adding these coated grains to a batch for producing a refractory product allows to obtain a high-quality refractory product, without the need of adding grains made of bulk silicon carbide to said batch.

Since the silicon carbide is present primarily in the coating, only a low amount of silicon carbide is needed compared to the total mass of the batch to efficiently increase the corrosion resistance of the final product. This is also advantageous in view of the limited availability and high costs of silicon carbide.

The present invention is particularly suitable to improve the corrosion resistance and physical properties of refractory raw material grains of lower quality, such as refractory raw materials which have been obtained from natural sources with no or only a few treatment steps.

### SHORT DESCRIPTION OF THE FIGURES

FIG. 1 shows a flow chart of the method for producing silicon carbide coated refractory grains as described herein.

FIG. 2 shows optical microscopy images of silicon carbide coated bauxite grains obtained by coating core refractory grains of bauxite with silicon carbide using a silica sol.

FIG. 3 shows optical microscopy images of silicon carbide coated bauxite grains obtained by coating core refractory grains of bauxite with silicon carbide using polyvinyl alcohol.

FIG. 4 shows photographs of three sintered refractory bricks after a corrosion test, wherein the refractory bricks have been prepared from a batch in which the coarse grains are white fused alumina grains (FIG. 4A), a batch in which the coarse grains are uncoated bauxite grains (FIG. 4B) and a batch in which the coarse grains are a mixture of silicon carbide coated bauxite grains and uncoated bauxite grains (FIG. 4C).

FIG. 5 shows optical microscopy images of silicon carbide coated andalusite grains obtained by coating core refractory grains of andalusite with silicon carbide using a silica sol.

### DETAILED DESCRIPTION OF THE INVENTION

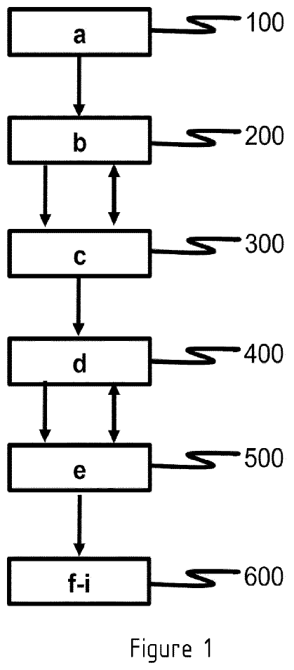

The method according to the invention comprises steps a to e, which may be performed sequentially or simultaneously (see FIG. 1). In the flow chart in FIG. 1, an arrow with two arrowheads indicates that the corresponding steps are performed simultaneously, i.e., in parallel, whereas an arrow with one arrowhead indicates that the corresponding steps are performed sequentially, i.e., one after the other.

In step a (see FIG. 1, 100), core refractory grains which are to be coated are provided. An oxide sol is sprayed onto the core refractory grains to wet the core refractory grains with the oxide sol (step b, see FIG. 1, 200). Spraying of the oxide sol is particularly advantageous for effectively distributing the sol over the surface of the grains. Spraying of the oxide sol onto the core refractory grains can be easily performed with a conventional spraying gun, allowing to wet the whole surface of the core refractory grains with the oxide sol in a time efficient manner. Additionally, it is possible to mix the core refractory grains during or after spraying the oxide sol onto the core refractory grains to further improve the wetting of the core refractory grains with the oxide sol (optional step c, see FIG. 1, 300). For mixing, a conventional and/or commercially available mixing device can be used. Step b and the optional mixing step c can be performed either sequentially or simultaneously (see FIG. 1). Preferably, the optional mixing step c is performed during the spraying step, i.e., simultaneously to the spraying step.

Silicon carbide grains are added to the wetted core refractory grains (step d, see FIG. 1, 400). Step d is preferably performed after step b, as shown in FIG. 1. In a less preferred embodiment, steps b and d may be performed simultaneously.

The mixture of wetted core refractory grains and silicon carbide grains is mixed to attach the silicon carbide grains to the core refractory grains (step e, see FIG. 1, 500). The steps of adding the silicon carbide grains and mixing (steps d and e may be performed either sequentially or simultaneously, preferably simultaneously (see FIG. 1). For mixing (step e, the same mixing device as in step c can be used. In particular, all steps a to e can be performed in the same mixing device.

Preferably, steps a, b and d are performed sequentially, while step c is performed simultaneously to step b and step e is performed simultaneously to step d. Particularly preferably, mixing can be performed constantly during steps b to e. The present invention allows to attach one or more silicon carbide coating layers to the core refractory grains. In this respect, the silicon carbide coated grains obtained from steps a to e described above may again serve as a starting material for attaching a further silicon carbide coating layer (see FIG. 1, 600).

According to one embodiment, the inventive method therefore further comprises the steps of:
f. Spraying an oxide sol onto said coated refractory grains;
g. Optionally mixing said coated refractory grains with said oxide sol in a mixing device;
h. Adding further silicon carbide grains to said coated refractory grains;
i. Mixing the mixture obtained in step h to obtain coated refractory grains having a further silicon carbide coating layer; and
j. Optionally repeating steps f to i one or more times to obtain coated refractory grains having one or more further silicon carbide coating layers.

By spraying an oxide sol onto the silicon carbide coated refractory grains (step f), the coated grains are wetted with the oxide sol. Optionally, the coated refractory grains are mixed in step g in an analogous manner as described for step c above. Silicon carbide grains are added to the wetted coated refractory grains (step h) and the mixture is mixed to attach further silicon carbide grains to the coated refractory grains (step i). Steps f to I may be performed sequentially and simultaneously in an analogous manner as described for steps a to e.

Steps f to i result in a coated refractory grain having a further silicon carbide coating layer, resulting in a total of two silicon carbide coating layers. Optionally, the steps f to i may be repeated one or more times to attach further silicon carbide coating layers to the coated grains (step j). The attachment of each silicon carbide coating layer is herein also referred to as a “coating cycle”.

It is preferred to perform one to three coating cycles, e.g., two coating cycles. Advantageously, a high number of repeating coating cycles can be avoided by using an oxide sol to attach the silicon carbide to the surface of the grains to be coated, because the oxide sol allows excellent adhesion of the silicon carbide to the surface. Therefore, it is possible to quickly and easily obtain coated refractory grains having a thick and uniform silicon carbide coating.

After finishing the coating cycles, the silicon carbide coated refractory grains can be dried, e.g., by storing them at room temperature or above room temperature, e.g., in a drying oven.

According to the present invention, it is preferred that the silicon carbide grains are significantly smaller than the core refractory grains to ensure a uniform coating and similar coating structure for each coated grain.

Thus, preferably, the core refractory grains have a particle size distribution with a first d50 value and the silicon carbide grains have a particle size distribution with a second d50 value, wherein said first d50 value is higher than said second d50 value by a factor of at least 50, preferably at least 100, more preferably at least 500.

As commonly known, the “d50 value” indicates a particle size (also called “grain size”) for a grain mixture in which 50% by mass of the grain mixture has a particle size according to the d50 value and below, and 50% by mass of this grain mixture has a particle size above the d50 value.

Preferably, the first d50 value, i.e., the d50 value of the core refractory grains, is at least 0.5 mm, preferably at least 1 mm. The d50 value of the core refractory grains may be up to 7 mm. This range of d50 values is preferred because common refractory raw materials are available in these grain sizes. The d50 value of said core refractory grains can be determined by using a laser diffraction method according to ISO 13320-1:2020 and by using sieve analysis according to DIN EN 1402-3.

Preferably, the second d50 value, i.e., the d50 value of the silicon carbide grains, ranges from 0.5 to 6 μm. This range of d50 values of the silicon carbide grains is preferred because it ensues a sufficient size difference to the core refractory grains and allows to use commercially available silicon carbide grains in the present invention. The d50 value of said silicon carbide grains can be determined by using a laser diffraction method according to ISO 13320-1:2020.

The oxide sol preferably comprises oxide particles having a particle size distribution with a d50 value below 100 nm. Preferably, the d50 of the oxide particles ranges from 1 nm to 100 nm, even more preferably from 20 nm to 50 nm. A d50 value below 100 nm is advantageous to ensure that the oxide particles form a colloidal dispersion in the liquid. The d50 value of said oxide particles can be determined by using a laser diffraction method according to ISO 13320-1:2020.

Further, the concentration of oxide particles in said oxide sol is also chosen to achieve a stable colloidal dispersion. Preferably, the oxide sol comprises oxide particles in a concentration of 15 wt. % to 60 wt. %, preferably 30 wt. % to 50 wt. %, based on the total weight of said oxide sol. If an oxide sol with an oxide particle concentration in the range of 15 wt. % to 60 wt. % is used, an efficient wetting of the core refractory grains and sufficient adhesion of the silicon carbide grains to the core refractory grains is achieved. If the concentration of oxide particles is lower than 15 wt. %, i.e., if the oxide sol comprises a large amount of liquid compared to solids, the adhesion of the silicon carbide grains to the core refractory grains might be reduced. If the oxide particle concentration is higher than 60 wt. %, i.e., if the sol comprises a lower amount of liquid compared to solids, the wetting of the core refractory grains might be negatively affected, possibly resulting in grains which are not fully wetted by the oxide sol.

According to the present invention, the thickness of the silicon carbide coating can be adjusted by adjusting the mass ratio between the core refractory grains and the silicon carbide grains. Preferably, the mass ratio between said core refractory grains and said silicon carbide grains ranges from 70:30 to 99:1, preferably from 80:20 to 95:5. The total amount of the silicon carbide grains may be attached to the core refractory grains in one or more than one coating cycles, as described above. Specifically, it has been shown that a small amount of silicon carbide grains relative to the amount of core refractory grains is sufficient to obtain a good coating thickness.

For example, it has been found that silicon carbide coatings with a thickness of 100 μm or more can be obtained when core refractory grains having a d50 value of around 1-3 mm and silicon carbide grains having a d50 value of around 2-3 μm are used, with a mass ratio of the core refractory grains and the silicon carbide grains of about 85:15 to 90:10. This coating thickness can be obtained in one or two coating cycles.

The present invention allows to coat a wide range of core refractory grains with silicon carbide.

Preferably, the core refractory grains comprise or consist of at least one of the following: aluminium oxide, aluminium silicate, magnesium oxide, magnesium aluminate, calcium oxide, calcium magnesium oxide, silicon dioxide.

More preferably, the core refractory grains are based on a compound selected from the group consisting of aluminium oxide, aluminium silicate, magnesium oxide, calcium oxide, calcium magnesium oxide and silicon dioxide.

The term “based on” in this context means that the grains comprise the compound to at least 60 wt. %, preferably at least 75 wt. %, even more preferably at least 85 wt. %.

According to a particularly preferred embodiment, the core refractory grains are based on aluminium oxide. Core refractory grains based on aluminium oxide can be provided in the form of bauxite, brown fused alumina, white fused alumina, calcined alumina, tabular alumina, or in the form of corundum.

Particularly preferably, the core refractory grains are bauxite grains. Generally, it is desired to prepare refractory products from bauxite, because bauxite is a cheap and easily available refractory raw material, and its preparation requires less time and cost efforts compared to e.g., preparing brown fused alumina, white fused alumina, calcined alumina or tabular alumina. However, refractory products made from bauxite are known to be of lower quality than refractory products made of brown fused alumina, white fused alumina, calcined alumina or tabular alumina, especially in terms of their corrosion resistance and physical properties such as the cold crushing strength.

According to the present invention, a silicon carbide coating on bauxite grains can be obtained. The silicon carbide coating significantly improves the chemical and physical properties of the bauxite grains, as reflected in improved corrosion resistance and e.g., in a higher cold crushing strength in products obtained from a batch based on bauxite and comprising silicon carbide coated bauxite grains compared to products obtained from a batch based on bauxite without coated grains. Thus, the present invention allows to obtain high-quality refractory products based on bauxite as a raw material, which is not only beneficial for economic reasons but also allows to widen the fields of applications of bauxite-based refractory products.

Of course, the present invention can also be used to obtain a silicon carbide coating on brown fused alumina, white fused alumina, calcined alumina or tabular alumina, or corundum, to further improve the chemical and physical properties of these raw materials.

According to another preferred embodiment, the core refractory grains are based on aluminium silicate, i.e., on a compound with the chemical formula xAl₂O₃·ySiO₂·zH₂O (wherein x and y are natural numbers equal or greater than 1 and z is 0 or a natural number equal or greater than 1). Core refractory grains based on aluminium silicate can be provided in the form of mullite, andalusite, kyanite, sillimanite, kaolinite or in the form of fireclay. Like bauxite, these raw materials are cheap and easily available. Also, for these materials, it is desired to be able to tune their corrosion resistance. Thus, the present invention allows to obtain grains of mullite, andalusite, kyanite, sillimanite, kaolinite grains or fireclay which are coated with silicon carbide, thereby increasing the fields of possible applications for refractory products based on aluminium silicate. Preferably, the core refractory grains are andalusite grains (chemical formula: Al₂SiO₅).

According to another preferred embodiment, the core refractory grains are based on magnesium oxide. Core refractory grains based on magnesium oxide can for example be provided in the form of periclase. Providing grains of magnesium oxide, such as periclase, coated with silicon carbide has the advantage of improving the corrosion resistance of the grains. Further, SiC-coated MgO grains can act as elastifier and/or flexibilizer when added to uncoated MgO grains.

According to another preferred embodiment, the core refractory grains are based on calcium magnesium oxide. Core refractory grains based on calcium magnesium oxide can be provided in the form of doloma.

According to another preferred embodiment, the core refractory grains are based on magnesium aluminate. Core refractory grains based on magnesium aluminate can be provided in the form of spinel.

The present invention further allows using a wide range of oxide sols to attach silicon carbide to the core refractory grains. The main components of the oxide sol are oxide particles and a liquid. The oxide sol may further comprise other compounds such as stabilizers and/or additives such as surfactants.

Preferably, the liquid is water, i.e., it is preferred that the oxide sol is an aqueous oxide sol. The liquid may also be an alcohol or any other polar organic solvent that is able to stabilize colloidal particles of an oxide.

Preferably, the oxide in the oxide sol is selected from the group consisting of silicon dioxide, magnesium oxide, calcium oxide and aluminium oxide.

Particularly preferably, the oxide particles consist of silicon dioxide. Using a silicon dioxide sol (herein also referred to as “silica sol”) to attach the silicon carbide coating to the core refractory gains is preferred. It has been found that using a silicon dioxide sol for attaching the SiC coating to the core refractory grains results in particularly thick and uniform SiC coatings.

According to a particularly preferred embodiment of the present invention, said core refractory grains are bauxite grains and said oxide sol is a silicon dioxide sol. This combination is particularly suitable to achieve thick and uniform silicon carbide coatings on bauxite grains.

In other embodiments, it is also favorable to choose the oxide in the oxide sol to chemically match the chemical composition of the core refractory grains. For example, for a core refractory grain based on magnesium oxide, a magnesium oxide sol may be used.

According to one embodiment of the present invention, said core refractory grains are periclase grains and said oxide sol is a magnesium oxide sol.

In another aspect, the present invention provides coated refractory grains produced by the method described herein.

The coated refractory grains according to the present invention comprise a core refractory grain and at least one coating layer comprising agglomerates of oxide particles and silicon carbide grains. The chemical composition of the core refractory grain may be chosen as described above.

As described herein, the coated grains are produced by using an oxide sol to attach the silicon carbide coating to the core refractory grains. In the coated grains, the liquid of the oxide sol evaporates and the oxide particles from the sol form agglomerates of oxide particles, which are present in the coating layer. Thus, an “agglomerate of oxide particles” is to be understood as a number of oxide particles originating from the oxide sol sticking together.

The agglomerates of oxide particles in the coating further function as a “glue” and gap filler between the silicon carbide grains and the core grains as well as between silicon carbide grains.

The agglomerates of oxide particles are composed of a number of individual oxide particles sticking together, said individual oxide particles preferably having a particle size distribution with a d50 value between 1 nm to 100 nm. The agglomerates may contain, e.g., 10 or more than 10, or more than 15, or more than 20 individual oxide particles. The average diameter of said agglomerates of oxide particles may range up to 10 μm or more. The coating structure and the average diameter of the agglomerates of oxide particles may be analyzed using scanning electron microscopy (SEM) or transmission electron microscopy (TEM).

In the coated refractory grain according to the invention, the majority of said agglomerates of oxide particles are preferably located close to the surface of the core refractory grain in case of the first coating layer, or close to the outer surface of the previous coating layer in case the grain has more than one coating layer. Therefore, preferably, at least 80% of said agglomerates of oxide particles are located in a first section of each of said at least one coating layer, said first section extending to a height of up to 20% of the thickness of each coating layer.

Preferably, the coated refractory grain according to the present invention is fully coated with said at least one silicon carbide coating layer. This means that the whole surface of the core refractory grain is preferably covered by silicon carbide.

As mentioned above, one or more coating cycles can be performed to produce a silicon carbide coated grain with one or more coating layers. The sum of the one or more coating layers is herein also referred to as “silicon carbide coating”. Preferably, the sum of the thicknesses of the one or more silicon carbide coating layers is on average at least 50 μm. This means that the core refractory grains preferably have a silicon carbide coating with an average thickness of at least 50 μm. Preferably, the silicon carbide coating has an average thickness of at least 100 μm.

The average thickness of the silicon carbide coating may be determined by graphical analysis of images obtained by optical microscopy or of electron micrographs obtained by SEM or TEM. The average thickness of the coating of a single grain—herein also referred to as “individual average coating thickness”—may for example be determined by measuring the thickness of the coating at several positions, preferably at least at 5 positions, around the circumference of the grain, followed by calculating the average value.

The method described herein of course results in a plurality of silicon carbide coated refractory grains. If a plurality of silicon carbide coated refractory grains is considered, the total average coating thickness of the plurality of the silicon carbide coated refractory grains may be determined. The total average coating thickness may for example be determined by first determining the individual average coating thickness of a statistically significant number of individual grains, followed by determining the average value of the individual average coating thicknesses.

It is preferred that the total average coating thickness of a plurality of silicon carbide coated grains is at least 50 μm. Therefore, if a plurality of grains is analyzed, it is possible that some grains have an average individual coating thickness below 50 μm, whereas other grains have an average coating thickness above 50 μm, wherein the total average value for the coating thickness is preferably above 50 μm.

In yet another aspect, the present invention provides a batch for producing a shaped refractory product comprising silicon carbide coated refractory grains as described herein, and a binder, wherein said batch comprises at least 5 wt. %, preferably at least 10 wt. % or 20 wt. %, of said silicon carbide coated refractory grains in relation to the total weight of the batch.

The batch may also comprise uncoated refractory grains, preferably uncoated refractory grains comprising or consisting of at least one of the following: aluminium oxide, aluminium hydroxide, aluminium silicate, magnesium oxide, magnesium aluminate, calcium oxide, calcium magnesium oxide, silicon dioxide.

More preferably, the uncoated refractory grains are based on a compound selected from the group consisting of aluminium oxide, aluminium silicate, magnesium oxide, calcium oxide, calcium magnesium oxide and silicon dioxide.

Preferably, the chemical composition of the uncoated refractory grains corresponds to the chemical composition of the core of the coated refractory grains. For example, if the core refractory grains are based on aluminium oxide, the uncoated refractory grains present in the inventive batch may also be based on aluminium oxide and therefore, the uncoated grains might be grains of bauxite, brown fused alumina, white fused alumina, calcined alumina, tabular alumina, or corundum, or a mixture thereof.

According to a specifically preferred embodiment, the coated grains are silicon carbide coated bauxite grains and the uncoated refractory grains are bauxite grains.

If the core refractory grains are based on aluminium silicate, the uncoated refractory grains present in the inventive batch may also be based on aluminium silicate and therefore the uncoated refractory grains might be grains of mullite, andalusite, kyanite, sillimanite, kaolinite, or fireclay, or a mixture thereof.

If the core refractory grains are based on magnesium oxide, the uncoated refractory grains present in the inventive batch may also be based on magnesium oxide and therefore the uncoated refractory grains might be grains of periclase.

Of course, it is also possible that the uncoated refractory grains have a different chemical composition than the core of the coated refractory grains. For example, it is possible that the core refractory grains are bauxite grains, whereas the uncoated refractory grains are based on aluminium silicate or on magnesium oxide.

The present invention further provides a method for producing a shaped refractory product comprising the steps of providing a batch as described herein and shaping and thermally treating said batch by tempering and/or sintering to produce a shaped refractory product.

Preferably, the batch described herein is used to produce a shaped refractory product, preferably in the form of a ceramically bonded or a carbon bonded refractory brick, preferably a ceramically bonded or a carbon-bonded non-basic refractory brick. The term “non-basic refractory brick” refers to a refractory brick based on non-basic raw materials, such as aluminium oxide or aluminium silicate.

As commonly known, a “ceramically bonded” refractory brick is bonded by sintering, i.e., by burning a green body at a temperature of above 1200° C. The batch may comprise a binder such as dextrin, which helps to obtain a sufficient strength of the green body.

A “carbon bonded” refractory brick is herein understood as a refractory brick bonded by carbon bonds. If a carbon bonded refractory brick is to be produced, the inventive batch further comprises a carbon-based component, e.g., a carbon-based component in the form of graphite, and an organic binder. The organic binder may be in the form of at least one binder known in the prior art, such as pitch or synthetic resin. The synthetic resin may be a phenolic resin. To produce a carbon-bonded refractory product, the batch is shaped and tempered, i.e., thermally treated at a temperature, which is preferably below 300° C. or 350° C. According to one embodiment, the shaped refractory product is a non-basic sintered refractory brick based on aluminium oxide or aluminium silicate.

By way of example, a batch for producing a sintered refractory brick based on aluminium oxide may comprise silicon carbide coated bauxite grains in a proportion of 5 to 15 wt. % based on the total amount of the batch and uncoated grains based on aluminium oxide in a proportion of 95 to 80 wt. %. The uncoated grains based on aluminium oxide may be a mixture of bauxite grains and one or more of brown fused alumina grains, white fused alumina grains, calcined alumina grains, tabular alumina grains, and corundum grains. As a binder, for example dextrin in an amount of about 1.5 to 3 wt. %, e.g., 2 wt. %, based on the total mass of the batch may be used.

For producing the sintered brick, the batch is shaped to a green body and thermally treated by sintering. Thereby, a shaped refractory brick comprising silicon carbide coated refractory grains is obtained. If the sintering step is performed in a non-reducing atmosphere, e.g., under air, the silicon carbide in the silicon carbide coated refractory grains is at least partially oxidized to silicon dioxide.

Such sintered bricks can for example be applied in the glass industry.

According to another preferred embodiment, the shaped refractory product is a non-basic carbon-bonded refractory brick based on aluminium silicate, i.e., an alumina silicon carbide carbon (ASC) brick.

By way of example, a batch for producing an ASC brick may comprise silicon carbide coated bauxite grains or silicon carbide coated grains based on aluminium silicate, e.g., in a proportion of 10 to 90 wt %, preferably 20 to 60 wt % based on the total amount of the batch. The batch may further comprise uncoated grains based on mullite, andalusite, kyanite, sillimanite, kaolinite, or fireclay, or a mixture thereof, e.g., in a proportion of 10 to 90 wt. %, preferably 40 to 80 wt %, as well as a carbon-based component, preferably graphite, e.g., in a proportion of 1 to 15 wt. % based on the total mass of the batch. The batch may also comprise silicon carbide grains. As a binder, an organic binder based on synthetic resin can be used, wherein the binder is present in the batch in a proportion in the range from 1 to 10 wt. % based on the total mass of the batch.

ASC bricks can for example be applied in the steel industry, e.g., as lining material of torpedo ladle cars.

In summary, the present invention covers the following embodiments:
1. A method for producing silicon carbide coated refractory grains, said method comprising the steps of:
   a. Providing core refractory grains;
   b. Spraying an oxide sol onto said core refractory grains;
   c. Optionally mixing said core refractory grains with said oxide sol in a mixing device;
   d. Adding silicon carbide grains to said core refractory grains; and
   e. Mixing the mixture obtained in step d to obtain coated refractory grains having a core and a first silicon carbide coating layer.
2. The method according to embodiment 1, further comprising the steps of:
   f. Spraying an oxide sol onto said coated refractory grains;
   g. Optionally mixing said coated refractory grains with said oxide sol in a mixing device;
   h. Adding further silicon carbide grains to said coated refractory grains;
   i. Mixing the mixture obtained in step h to obtain coated refractory grains having a further silicon carbide coating layer; and
   j. Optionally repeating steps f to i one or more times to obtain coated refractory grains having one or more further silicon carbide coating layers.
3. The method according to embodiment 1 or 2, wherein said core refractory grains comprise or consist of at least one of the following: aluminium oxide, aluminium silicate, magnesium oxide, magnesium aluminate, calcium oxide, calcium magnesium oxide, silicon dioxide.
4. The method according to any one of embodiments 1 to 3, wherein said core refractory grains are selected from the group consisting of bauxite grains, mullite grains, andalusite grains, kyanite grains, sillimanite grains, kaolinite grains and fireclay grains.
5. The method according to any one of embodiments 1 to 4, wherein said oxide sol comprises oxide particles consisting of an oxide selected from the group consisting of silicon dioxide, magnesium oxide, calcium oxide and aluminium oxide, said oxide particles preferably consisting of silicon dioxide.
6. The method according to any one of embodiments 1 to 5, wherein said core refractory grains are bauxite grains and said oxide sol is a silicon dioxide sol.
7. The method according to any one of embodiments 1 to 6, wherein said core refractory grains are periclase grains and said oxide sol is a magnesium oxide sol.
8. The method according to any one of embodiments 1 to 7, wherein said core refractory grains have a particle size distribution with a first d50 value and said silicon carbide grains have a particle size distribution with a second d50 value, wherein said first d50 value is higher than said second d50 value by a factor of at least 50, preferably at least 100, more preferably at least 500.
9. The method according to any one of embodiments 1 to 8, wherein said first d50 value is at least 0.5 mm, preferably at least 1 mm.
10. The method according to any one of embodiments 1 to 9, wherein said second d50 value ranges from 0.5 to 6 μm.
11. The method according to any one of embodiments 1 to 10, wherein said oxide sol comprises oxide particles in an amount of at least 15 wt. % based on the total weight of said oxide sol.
12. The method according to any one of embodiments 1 to 11, wherein said oxide sol comprises oxide particles having a particle size distribution with a d50 value below 100 nm.
13. The method according to any one of embodiments 1 to 12, wherein the mass ratio between said core refractory grains and said silicon carbide grains ranges from 70:30 to 99:1.
14. Coated refractory grains produced by the method according to any one of embodiments 1 to 13.
15. A silicon carbide coated refractory grain comprising the following components:
   a. A core refractory grain having a particle size distribution with a first d50 value, and
   b. at least one coating layer, wherein said at least one coating layer comprises the following components:
      i. agglomerates of oxide particles, and
      ii. silicon carbide grains, wherein said silicon carbide grains have a particle size distribution with a second d50 value, said first d50 value being higher than said second d50 value.
16. The silicon carbide coated refractory grain according to embodiment 15, wherein said core refractory grain comprises or consists of at least one of the following: aluminium oxide, aluminium hydroxide, aluminium silicate, magnesium oxide, magnesium aluminate, calcium oxide, calcium magnesium oxide, silicon dioxide.
17. The silicon carbide coated refractory grain according to embodiments 15 or 16, wherein said oxide particles consist of at least one of the following: silicon dioxide, magnesium oxide, calcium oxide, aluminium oxide, wherein said oxide particles preferably consist of silicon dioxide.
18. The silicon carbide coated refractory grain according to any one of embodiments 15 to 17, wherein said core refractory grain is a bauxite grain and said oxide particles consist of silicon dioxide.
19. The silicon carbide coated refractory grain according to any one of embodiments 15 to 18, wherein said core refractory grain is fully coated with said at least one silicon carbide coating layer.
20. The silicon carbide coated refractory grain according to any one of embodiments 15 to 19, wherein said at least one silicon carbide coating layer has an average thickness of at least 50 μm.
21. The silicon carbide coated refractory grain according to any one of embodiments 15 to 20, wherein at least 80% of said agglomerates of oxide particles are located in a first section of each of said at least one silicon carbide coating layer, said first section extending to a height of up to 20% of the thickness of each silicon carbide coating layer.
22. A batch for producing a shaped refractory product, said batch comprising silicon carbide coated refractory grains as defined in any one of embodiments 15 to 21 and a binder, wherein said batch comprises at least 5 wt %, preferably at least 10 or 20 wt %, of said silicon carbide coated refractory grains in relation to the total weight of the batch.
23. The batch according to embodiment 22, further comprising uncoated refractory grains, wherein said uncoated refractory grains comprise or consist of at least one of the following: aluminium oxide, aluminium hydroxide, aluminium silicate, magnesium oxide, magnesium aluminate, calcium oxide, calcium magnesium oxide, silicon dioxide.
24. A method for producing a shaped refractory product comprising the steps of:
   a. Providing a batch according to embodiment 22 or 23;
   b. Shaping and thermally treating said batch by tempering and/or sintering to a produce a shaped refractory product.
25. A shaped refractory product comprising silicon carbide coated refractory grains according to any one of embodiments 15 to 21.

The present invention is further illustrated below by exemplary and non-limiting examples.

### EXAMPLES

### Example 1: Preparation of Silicon Carbide Coated Bauxite Grains by Using Silica Sol

Silicon carbide coated bauxite grains were produced from the starting materials listed in Table 1.

TABLE 1
Starting materials for the production of
silicon carbide coated bauxite grains

| | Material description | d50 value | |
|---|---|---|---|
| Bauxite grains | Alumina content: 88 wt. %; grain bulk | 2 | mm |
| | density: 3.28 g/cm³; grain size: 1-3 mm; | | |
| | obtained from ShanXi JinYuLong Co. Ltd. | | |
| SiC grains | “90/95 GREEN POWER CN” obtained | 2.5 | μm |
| | from Yingkou Xianrendao | | |
| Silica sol | “LEVASIL CS40-68 P S03” obtained from | 34 | nm |

Nouryon

As can be seen from Table 1, bauxite grains with a grain size of 1-3 mm (d50=2 mm) were used. Of course, it is also possible to use larger grains as a starting material, e.g., bauxite grains with a grain size of 3-5 mm.

Commercially available silicon carbide grains (SiC grains) were used, having a d50 value of 2.5 μm.

Further, a commercially available silicon dioxide sol was used with silicon dioxide particles having a d50 value of 34 nm.

Silicon carbide coated bauxite grains were produced in two coating cycles as described in Table 2.

TABLE 2
Preparation of silicon carbide coated bauxite grains in two
coating cycles. The proportion of the materials are given
in wt. % based on the total mass of the starting materials.

| | | Proportion/ | |
|---|---|---|---|
| Step | Material | wt. % | Description |
| 1 | Bauxite | 83 | |
| | grains | | |
| 2 | Silica sol | 1 | Mixing 60 s after silica sol adding, |
| | | | bauxite grains wetted well |
| 3 | SiC grains | 10 | Mixing 120 s after adding SiC grains |
| 4 | Silica sol | 0.5 | Mixing 60 s after adding silica sol |
| 5 | SiC grains | 5.5 | Mixing 120 s after adding SiC grains |

First, the bauxite grains were placed into a conventional mixer (total amount of bauxite grains: 8.3 kg), and the mixer was kept running during the whole coating procedure. The rotating speed of the mixer was set to 24 rpm. After one minute, the silica sol was sprayed into the mixer by using a spraying gun. One minute later, the SiC grains were slowly poured into the mixer. Two minutes later, silica sol was sprayed into the mixer. After one further minute of mixing, SiC grains were poured into the mixer again. Two minutes later, the mixing was stopped, and the silicon carbide coated bauxite grains were obtained.

Afterwards, the silicon carbide coated bauxite grains were removed from the mixture and the grains were dried at room temperature for one day. Of course, the grains could for example also be dried at elevated temperatures, for example in a drying oven, which may be preferably operated at a temperature of up to 80° C.

After drying, the coated grains were analyzed using optical microscopy. For the microscopical analysis, the samples were put into a conventional resin and polished.

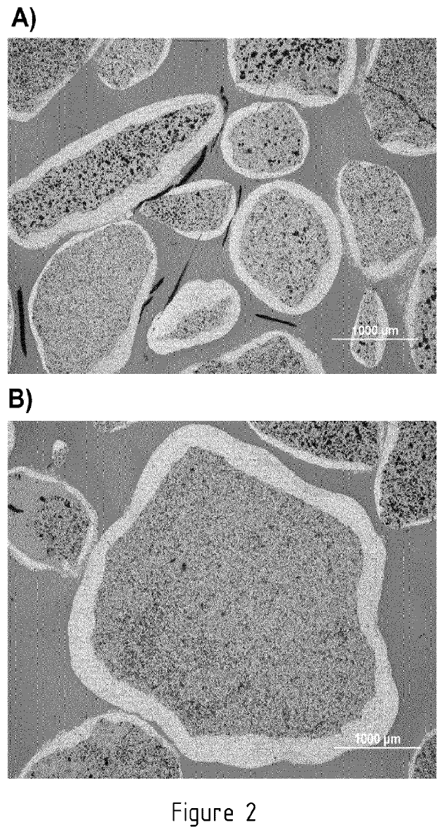

FIG. 2 shows two optical microscopy images of the silicon carbide coated bauxite grains obtained as described above. FIG. 2A is an overview image of several coated grains and FIG. 2B shows an individual coated grain (scale: 1000 μm). The images show thick and uniform coatings of silicon carbide, and average coating thickness was determined to be about 150 μm.

### Comparative Example 1: Preparation of Silicon Carbide Coated Bauxite Grains by Using Polyvinyl Alcohol

Silicon carbide coated bauxite grains were produced in an analogous way as described in example 1, with the exception that polyvinyl alcohol was used instead of silica sol for attaching the silicon carbide grains to the bauxite grains.

After drying, the coated grains were again analyzed using optical microscopy.

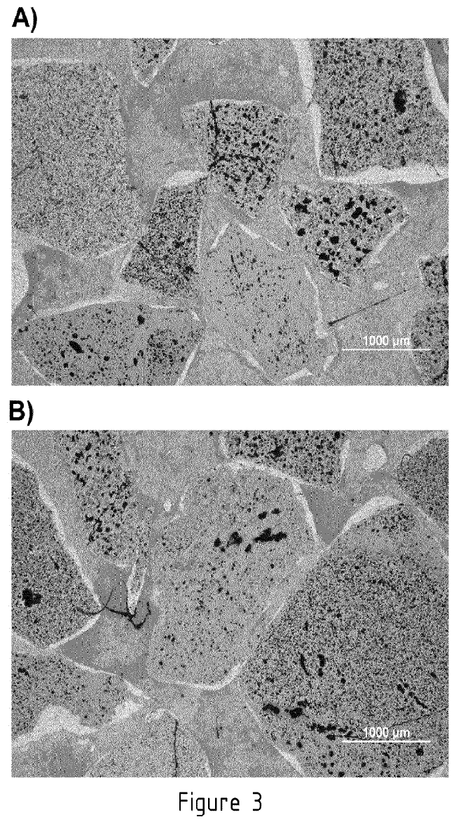

FIG. 3 shows two optical microscopy images of the silicon carbide coated bauxite grains obtained by using polyvinyl alcohol. FIG. 3A is an overview image of several grains and FIG. 3B shows an individual coated grain (scale: 1000 μm).

As can be seen from FIGS. 3A and 3B, the silicon carbide coating is very thin, and the grains are not fully coated by silicon carbide.

In particular, it was observed that the silicon carbide grains do not stick to the surface of the bauxite grains if polyvinyl alcohol was used. Rather, the silicon carbide grains tended to “fall off” the bauxite grains.

### Example 2: Preparation of a Sintered Refractory Brick from a Batch Comprising Silicon Carbide Coated Bauxite Grains

Three batches as described in Table 3 were provided for producing sintered (i.e., ceramically bonded) refractory bricks:

TABLE 3
Composition of batches 1, 2 and 3

| | Batch 1 | Batch 2 | Batch 3 |
|---|---|---|---|
| Description | Amount/g | Amount/g | Amount/g |
| White fused alumina grains: 1-3 mm | 380 | | |
| Bauxite grains: 1-3 mm | | 380 | 280 |
| SiC coated bauxite grains as | | | 100 |
| obtained from Example 1 | | | |
| White fused alumina grains: 0-1 mm | 450 | 450 | 450 |
| Chromium oxide (“Green GX-1100” | 120 | 120 | 120 |
| obtained from Gansu Jinshi, | | | |
| Luoyang Zhengjieke) | | | |
| Binder (dextrin) | 20 | 20 | 20 |
| Others | 70 | 70 | 70 |
| Total | 1040 | 1040 | 1040 |

Batch 1 is a batch in which the coarse grains are white fused alumina grains, which is an expensive and high-quality alumina raw material. Batch 2 is a batch in which the coarse grains are uncoated bauxite grains, i.e., a lower quality alumina raw material. In batch 3 the coarse grains are a mixture of uncoated bauxite grains and silicon carbide coated bauxite grains.

Each batch contained fine grains made of white fused alumina, and dextrin as a binder. The batches further contained chromium oxide to create chromium alumina phases, which contribute to the improvement of the corrosion resistance. The batches further contained other compounds such as agents to promote sintering.

Each batch was shaped to a green body and then sintered at 1500° C. for 6 hours.

For the bricks obtained from batches 1, 2 and 3 the following physical parameters were determined: bulk density, apparent porosity, and cold crushing strength (CCS). As can be seen from table 4, the brick obtained from batch 3 shows similar properties to the brick obtained from batch 1, whereas the brick obtained from batch 2 shows a significantly lower apparent porosity and CCS. Regarding the CCS, the brick produced from batch 3 even outperformed the brick produced from batch 1.

TABLE 4
physical test results for bricks obtained from batches 1, 2 and 3

| | | Batch 1 | Batch 2 | Batch 3 |
|---|---|---|---|---|
| Bulk | g/cm³ | 3.26 | 3.11 | 3.03 |
| Density | | | | |
| Apparent | Vol % | 17.5 | 17 | 17.5 |
| porosity | | | | |
| CCS | MPa | 96.1 | 79.7 | 100.2 |

The bricks obtained from batches 1, 2 and 3 were further exposed to a corrosion test. For this test, the bricks were cut into crucibles, and a slag obtained from the glass industry, comprising mainly alkali salts and sulfates, was put inside. Then, the samples were fired at 1500° C. for 6 hours.

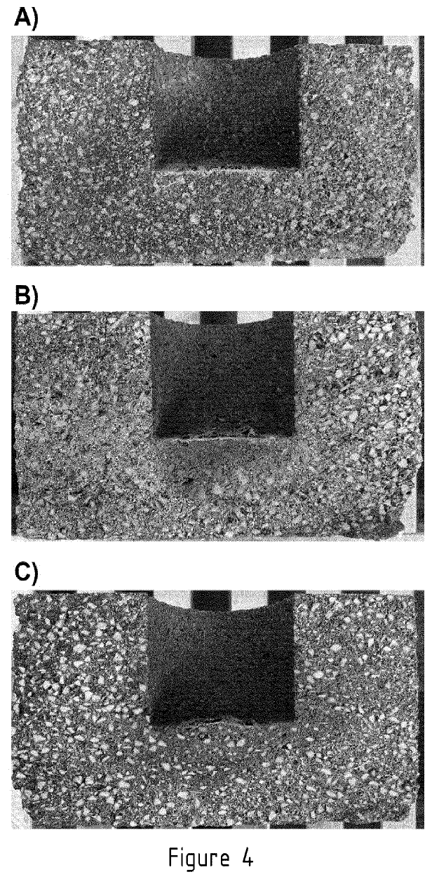

The results of the corrosion test are shown in the photographs in FIG. 4. FIG. 4A shows the brick prepared from batch 1 after the corrosion test. FIG. 4B shows the brick prepared from batch 2 after the corrosion test and FIG. 4C shows the brick prepared from batch 3 after the corrosion test. As can be seen in FIG. 4B, the brick based on batch 2 (uncoated bauxite grains) shows largely corroded areas, whereas the brick obtained from batch 1 (white fused alumina grains) and the brick obtained from batch 3 (mixture of silicon carbide coated bauxite grains and uncoated bauxite grains) show much less corroded areas. The bricks produced from batch 1 and 3 performed similarly in the corrosion test. The above results demonstrate that adding silicon carbide coated bauxite grains to a batch based on bauxite grains significantly improves the physical and chemical properties of the resulting brick. In particular, similar or even better properties can be obtained from such a batch when compared to a batch based on an expensive high-quality alumina raw material like white fused alumina.

Replacing batch 1 by batch 3 therefore for example allows to reduce the costs for producing the shaped refractory product while maintaining or even improving the physical and chemical properties.

### Example 3: Preparation of Silicon Carbide Coated Andalusite Grains by Using Silica Sol

Silicon carbide coated andalusite grains were produced from the starting materials listed in Table 5.

TABLE 5
Starting materials for the production of
silicon carbide coated andalusite grains

| | Material description | d50 value | |
|---|---|---|---|
| Andalusite | Composition: 90 wt. % Al₂SiO₅; grain bulk | 2 | mm |
| grains | density: 3.15 g/cm³; grain size: 1-3 mm; | | |
| | obtained from Tianjin Cofermin | | |
| SiC grains | “90/95 GREEN POWER CN” obtained | 2.5 | μm |
| | from Yingkou Xianrendao | | |
| Silica sol | “LEVASIL CS40-68 P S03” obtained from | 34 | nm |

Nouryon

Commercially available silicon carbide grains (SiC grains) were used, having a d50 value of 2.5 μm.

Further, a commercially available silicon dioxide sol was used with silicon dioxide particles having a d50 value of 34 nm.

Silicon carbide coated bauxite grains were produced in two coating cycles as described in Table 6.

TABLE 6
Preparation of silicon carbide coated andalusite grains in two
coating cycles. The proportion of the materials are given in
wt. % based on the total mass of the starting materials.

| | | Proportion/ | |
|---|---|---|---|
| Step | Material | wt. % | Description |
| 1 | Andalusite | 83 | |
| | grains | | |
| 2 | Silica sol | 1 | Mixing 60 s after silica sol adding, |
| | | | bauxite grains wetted well |
| 3 | SiC grains | 10 | Mixing 120 s after adding SiC grains |
| 4 | Silica sol | 0.5 | Mixing 60 s after adding silica sol |
| 5 | SiC grains | 5.5 | Mixing 120 s after adding SiC grains |

In summary, mixing and drying was performed as described for silicon carbide coated bauxite grains in Example 1.

After drying, the coated grains were analyzed using optical microscopy. For the microscopical analysis, the samples were put into a conventional resin and polished.

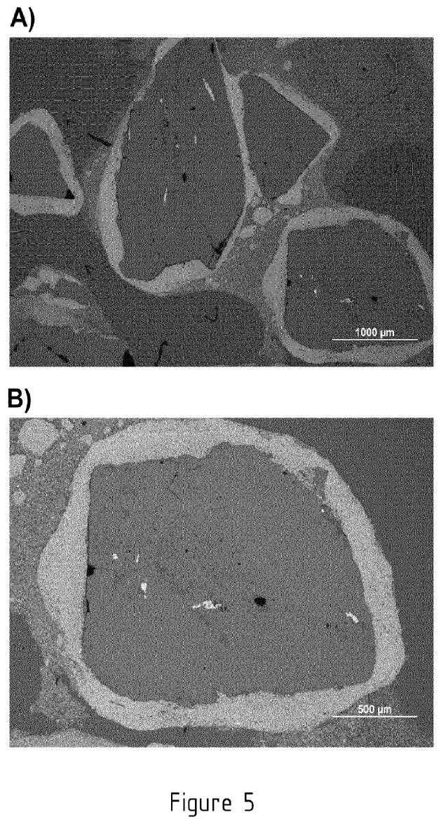

FIG. 5 shows two optical microscopy images of the silicon carbide coated andalusite grains obtained as described above. FIG. 5A is an overview image of several coated andalusite grains (scale: 1000 μm) and FIG. 5B shows an individual coated andalusite grain (scale: 500 μm). The average coating thickness was determined to be about 100 μm.

1. A method for producing silicon carbide coated refractory grains, said method comprising the steps of:
a. Providing core refractory grains;
b. Spraying an oxide sol onto said core refractory grains;
c. Optionally mixing said core refractory grains with said oxide sol in a mixing device;
d. Adding silicon carbide grains to said core refractory grains; and
e. Mixing the mixture obtained in step d to obtain coated refractory grains having a core and a first silicon carbide coating layer.

2. The method according to claim 1, further comprising the steps of:
f. Spraying an oxide sol onto said coated refractory grains;
g. Optionally mixing said coated refractory grains with said oxide sol in a mixing device;
h. Adding further silicon carbide grains to said coated refractory grains;
i. Mixing the mixture obtained in step h to obtain coated refractory grains having a further silicon carbide coating layer; and
j. Optionally repeating steps f to i one or more times to obtain coated refractory grains having one or more further silicon carbide coating layers.

3. The method according to claim 1 or 2, wherein said core refractory grains comprise or consist of at least one of the following: aluminium oxide, aluminium silicate, magnesium oxide, magnesium aluminate, calcium oxide, calcium magnesium oxide, silicon dioxide.

4. The method according to any one of claims 1 to 3, wherein said core refractory grains are selected from the group consisting of bauxite grains, mullite grains, andalusite grains, kyanite grains, sillimanite grains, kaolinite grains and fireclay grains.

5. The method according to any one of claims 1 to 4, wherein said oxide sol comprises oxide particles consisting of an oxide selected from the group consisting of silicon dioxide, magnesium oxide, calcium oxide and aluminium oxide, said oxide particles preferably consisting of silicon dioxide.

6. The method according to any one of claims 1 to 5, wherein said core refractory grains are bauxite grains and said oxide sol is a silicon dioxide sol.

7. The method according to any one of claims 1 to 6, wherein said core refractory grains have a particle size distribution with a first d50 value and said silicon carbide grains have a particle size distribution with a second d50 value, wherein said first d50 value is higher than said second d50 value by a factor of at least 50, preferably at least 100, more preferably at least 500.

8. A silicon carbide coated refractory grain comprising the following components:
a. A core refractory grain having a particle size distribution with a first d50 value, and
b. at least one coating layer, wherein said at least one coating layer comprises the following components:
i. agglomerates of oxide particles, wherein said oxide particles consist of at least one of the following: silicon dioxide, magnesium oxide, calcium oxide, aluminium oxide; and
ii. silicon carbide grains, wherein said silicon carbide grains have a particle size distribution with a second d50 value, said first d50 value being higher than said second d50 value.

9. The silicon carbide coated refractory grain according to claim 8, wherein said core refractory grain is a bauxite grain and said oxide particles consist of silicon dioxide.

10. The silicon carbide coated refractory grain according to claim 8 or 9, wherein said at least one silicon carbide coating layer has an average thickness of at least 50 μm.

11. A batch for producing a shaped refractory product, said batch comprising silicon carbide coated refractory grains as defined in any one of claims 8 to 10 and a binder, wherein said batch comprises at least 5 wt %, preferably at least 10 or 20 wt %, of said silicon carbide coated refractory grains in relation to the total weight of the batch.

12. The batch according to claim 11, further comprising uncoated refractory grains, wherein said uncoated refractory grains comprise or consist of at least one of the following: aluminium oxide, aluminium hydroxide, aluminium silicate, magnesium oxide, magnesium aluminate, calcium oxide, calcium magnesium oxide, silicon dioxide.

13. A method for producing a shaped refractory product comprising the steps of:
a. Providing a batch according to claim 11 or 12;
b. Shaping and thermally treating said batch by tempering and/or sintering to a produce a shaped refractory product.

14. A shaped refractory product comprising silicon carbide coated refractory grains according to any one of claims 8 to 10.
